(19) United States
(12) Patent Application Publication
(10) Pub. No.: US 2026/0048664 A1
(43) Pub. Date: Feb. 19, 2026

(54) POWER SUPPLY APPARATUS

(71) Applicants: Hyundai Motor Company, Seoul (KR); Kia Corporation, Seoul (KR); EGTRONICS Co., Ltd., Hwaseong-si (KR)

(72) Inventors: Soon Cheol Hwang, Hwaseong-si (KR); Eun Jin Jung, Seongnam-si (KR); Yoon Kyu Shin, Osan-si (KR); Ji Hyeong Lee, Hwaseong-si (KR); Chan Ho Kang, Suwon-si (KR); Meong Kyu Choi, Yongin-si (KR)

(73) Assignees: Hyundai Motor Company, Seoul (KR); Kia Corporation, Seoul (KR); EGTRONICS Co., Ltd., Hwaseong-si (KR)

(21) Appl. No.: 19/249,911

(22) Filed: Jun. 25, 2025

(30) Foreign Application Priority Data
Aug. 14, 2024 (KR) 10-2024-0109176

(51) Int. Cl. B60L 3/00; H02J 9/06

(52) U.S. Cl. CPC B60L 3/0092; B60L 3/0015; H02J 9/06; H02J 2310/48

(57) ABSTRACT

A power supply apparatus is provided. The apparatus includes a first converter configured to convert a voltage of power supplied from a power supply source into a first voltage, a first power distributor configured to distribute a current of the first voltage to first voltage loads, and a redundant power system configured to supply power to the first power distributor. The first power distributor includes a first switch configured to switch on or off an output when a current output to the first voltage loads is greater than or equal to a first reference value.

### CROSS-REFERENCE TO RELATED APPLICATIONS

The present application claims priority to Korean Patent Application No. 10-2024-0109176, filed on Aug. 14, 2024, the entire contents of which are incorporated herein for all purposes by this reference.

### TECHNICAL FIELD

The present disclosure relates to a power supply apparatus.

### BACKGROUND

A stable power supply is extremely important for an electronic device.

In particular, the stable power supply is further important when a safety accident occurs by a device malfunction caused by a power supply failure.

For example, when the power supply failure occurs in an autonomous vehicle, a limitation may occur in vehicle control due to an autonomous driving system, and the limitation may increase a risk of accident.

Since the autonomous vehicle requires a measure for the power supply failure, redundant power supply may serve as the measure.

Although redundant power supply technologies for general electronic devices are well-known, a technology suitable to the autonomous vehicle is required.

That is, a redundant power supply technology capable of managing various failure situations is required for autonomous vehicles.

### SUMMARY

At least one embodiment of the present disclosure provides a redundant power supply technology capable of managing various abnormal situations.

At least one embodiment of the present disclosure provides a redundant power supply apparatus capable of blocking power supply when an overcurrent flows through power loads.

At least one embodiment of the present disclosure also provides a redundant power supply apparatus capable of blocking a current flowing to a converter when a failure state of the converter that converts a voltage of a high-voltage battery for power supply to power loads occurs.

An embodiment of the present disclosure provides a power supply apparatus including: a first converter configured to convert a voltage of power supplied from a power supply source into a first voltage; a first power distributor configured to distribute the first voltage current to first voltage loads; and a redundant power system configured to supply power to the first power distributor, wherein the first power distributor includes a first switch configured to switch on/off an output when a current output from the first voltage loads is equal to or greater than a first reference value.

In an embodiment, the first switch may switch off as the current is output to the first converter.

In an embodiment, the power supply apparatus may further include a first controller configured to determine the first reference value through learning.

In an embodiment, the first power distributor may further include a second switch configured to switch an electrical connection with a first battery, and the first controller may switch off the second switch and perform the learning.

In an embodiment, the first controller may perform the learning on a first group among the first voltage loads based on monitored results of a current output according to an operation of the first converter and perform the learning on a second group among the first voltage loads by an amount of current consumption according to a forced output command.

In an embodiment, the first power distributor may include output elements corresponding respective groups among the first voltage loads, and the first controller may measure an output current of the output elements for respective groups and perform the learning.

In an embodiment, the first reference value may be determined as an accumulated average of current learning values obtained from learning performed a plurality of times.

In an embodiment, the first reference value may be updated as the learning is repeated, and the first reference value determined by each learning may be updated by an average with an excess value when a maximum current consumption of the first voltage loads is greater than the first reference value.

In an embodiment, the first controller may include a processor of the first power distributor.

In an embodiment, the first power distributor may include a first power line that connects the output current of the first converter to a portion of the first voltage loads and a second power line that connects the output current of the first converter to the rest and/or at least a portion of the portion of the first voltage loads, and the first switch may be connected between the first power line and the second power line.

In an embodiment, the redundant power system may be connected to the second power line.

In an embodiment, the redundant power system may include: a second converter configured to convert a voltage of power supplied from the power supply source into a second voltage; and a second power distributor configured to distribute the second voltage current to second voltage loads and receive redundant power from the first power distributor, the second power distributor may include a third switch configured to switch on/off an output when a current output from the second voltage loads is equal to or greater than a second reference value, and the power supply apparatus may further include a bidirectional converter connected between the first power distributor and the second power distributor.

In an embodiment, the third switch may be switched off as the current is output to the second converter.

In an embodiment, the power supply apparatus may further include a second controller configured to determine the second reference value through learning.

In an embodiment, the second power distributor may further include a fourth switch configured to switch an electrical connection with the second battery, and the second controller may switch off the fourth switch and perform the learning.

In an embodiment, the second controller may perform the learning on a third group among the second voltage loads based on monitored results of a current output according to an operation of the second converter and perform the learning on a fourth group among the second voltage loads by an amount of current consumption according to a forced output command.

In an embodiment, the second controller may include a processor of the second power distributor.

In an embodiment, the second power distributor may include a third power line that connects the output current of the second converter to a portion of the second voltage loads and a fourth power line that connects the output current of the second converter to the rest and/or at least a portion of the portion of the first voltage loads, and the third switch may be connected between the third power line and the fourth power line.

In an embodiment, the first power distributor may be connected to the fourth power line.

In an embodiment, the power supply apparatus may further include a bidirectional converter connected between the first power distributor and the second power distributor.

### BRIEF DESCRIPTION OF THE DRAWINGS

FIG. 1 is a view illustrating a power supply apparatus according to an embodiment of the present disclosure.

FIGS. 2 and 3 are flowcharts illustrating a learning process according to an embodiment of the present disclosure.

FIGS. 4 and 5 are flowcharts illustrating repeated learning processes according to an embodiment of the present disclosure.

FIG. 6 is a view illustrating a power supply apparatus according to another embodiment of the present disclosure.

### DETAILED DESCRIPTION OF ILLUSTRATIVE EMBODIMENTS

Since the present disclosure may have various modified embodiments, preferred embodiments are illustrated in the drawings and described in the detailed description of the disclosure. However, this does not limit the present disclosure to the specific embodiments, and it should be understood that the present disclosure covers all modifications, equivalents, and replacements within the spirit and technical scope of the present disclosure.

In this specification, the suffixes “module” and “unit” are used merely for nominal distinction between components and should not be interpreted as implying that the components are physically or chemically separated or that they can be separated.

It will be understood that although the terms of “first” and “second” are used herein to describe various elements, these elements should not be limited by these terms. These terms may be used solely to differentiate one component from another in name, and their sequential meanings are understood through the context of the description rather than by the names themselves.

The term “and/or” is used to include all possible combinations of the listed items. For example, “A and/or B” includes all three cases of “A”, “B”, and “A and B”.

It will also be understood that when an element is referred to as being “connected to” or “engaged with” another element, it can be directly connected to the other element, or intervening elements may also be present.

In the following description, the technical terms are used only for explaining a specific exemplary embodiment while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined otherwise, they may be construed as having meanings known to those skilled in the art. Terms that are generally used and appear in dictionaries should be construed as having meanings consistent with their contextual usage in the art. In this description, unless clearly defined, terms should not be excessively or narrowly construed based on formal definitions.

Also, the terms unit, control unit, control device, or controller are widely used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

On the other hand, the processor may include semiconductor integrated circuits and/or electronic elements that perform at least one or more of comparisons, determinations, calculations, and decisions to achieve programmed functions. For example, the processor may be a computer, a microprocessor, CPU, ASIC, an electronic circuitry (logic circuits), or a combination thereof.

Also, the computer readable recording medium (or memory) includes all sorts of data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media. The recording media and the processor may be integrated with each other or physically separated from each other.

Hereinafter, embodiments of the present general inventive concept will be described with reference to the drawing.

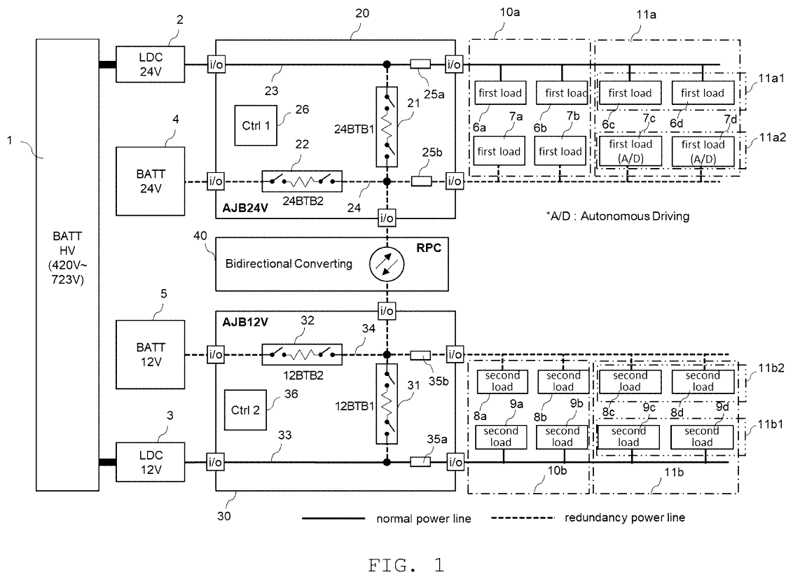

FIG. 1 is a view illustrating a power supply apparatus according to an embodiment of the present disclosure. FIG. 1 illustrates a topology of a power supply apparatus of an autonomous vehicle.

A vehicle according to an embodiment includes a high-voltage battery 1.

The high-voltage battery 1 may include a plurality of battery cells (not shown) that output a voltage of, e.g., 2.7 V to 4.2 V, and the set number of the plurality of battery cells may be connected in series or parallel to form one module. The high-voltage battery may be packaged such that one or more battery modules are connected in series or parallel as one battery to output, e.g., about 400 V, about 800 V, or several kV.

The power supply apparatus according to the embodiment may include a first power system and a second power system, and the two power systems may act mutually as redundant power systems.

To this end, a bidirectional converter 40 is connected between the first power system and the second power system. The bidirectional converter 40 converts a first voltage into a second voltage in response to a request from a second power distributor 30 that will be described later and converts the second voltage into the first voltage in response to a request from a first power distributor 20.

The first power system includes a first converter 2 and the first power distributor 20.

The first power distributor 20 receives power from the first converter 2 while driving and distributes the received power to a first battery 4 and first voltage loads. The first voltage loads are expressed by “Load 1” in FIG. 1.

The first converter 2 converts a voltage of the high-voltage battery 1 into the first voltage.

Although the first voltage is, e.g., a voltage of 24V as a rated voltage, the embodiment of the present disclosure is not limited thereto.

The first converter 10 may continuously output 28V power by converting the power of the high-voltage battery 1 when a startup state of an electric vehicle is an ‘EV Ready’ state.

The first battery 4, which has a rated voltage of 24V, may include two 12V lead-acid batteries.

The first power distributor 20 distributes the power supplied from the first converter 10 to the first battery 4 and the first voltage loads.

To this end, the first power distributor 20 includes a first normal power line 23 that connects the first converter 2 to the first voltage loads and a first redundant power line 24 that connects the first battery 4 and the bidirectional converter 40 in parallel to the first voltage loads.

The first power distributor 20 includes a first switch 21 that turns on/off an electrical connection between the second power system that supplies redundant power and the first converter 2 and a second switch 22 that turns on/off an electrical connection between the second power system and the first battery 4.

In this embodiment, the first switch 21 is connected between the first normal power line 23 and the first redundant power line 24, and the second switch 22 is connected between the first battery 4 and the first voltage loads on the first redundant power line 24. The second switch 22 is connected between the bidirectional converter 40 and the first battery 4 in terms of redundant power supply.

The power supply apparatus according to the embodiment includes a first controller that controls the first switch 21 and the second switch 22 based on a state of the first converter 2 and/or the first battery 4 and performs a first reference value learning that will be described later.

In this embodiment, the first power distributor 20 may include a memory in which a computer program of control logic is stored and a microprocessor that loads and executes the program from the memory. Also, the first controller may include a processor of the first power distributor 20. That is, for example, the processor of the first power distributor 20 may act as the first controller.

Also, the first power distributor 20 includes a first sensor 25a for sensing a voltage and/or current output from the first converter 2 and a second sensor 25b for sensing a voltage and/or current output as corresponding first voltage loads through the first redundant power line.

The first sensor 25a is disposed between the first normal power line 23 and the first switch 21, and the second sensor 25b is disposed at a rear end of a connection point between the first switch 21 and the first redundant power line 24.

When a current measured by the first sensor 25a is determined to be equal to or greater than the first reference value, the first power distributor 20 blocks power supplied to the first voltage loads through the first normal power line 23.

To this end, for example, the first power distributor 20 may turn off the first converter 2 and the first switch 21.

Also, when the first power distributor 20 may turn off the first switch 21 when a current output to the first converter 2 is detected.

Each of the first switch 21 and the second switch 22 may be a mechanical relay or a back-to-back switch.

The back-to-back switch may operate based on own algorithm of a decision logic. The back-to-back switch may be a semiconductor power element in which MOSFETs are mirrored and connected in parallel. Since the back-to-back switch may be a typically well-known switching element, a detailed description thereof will be omitted.

The second power system includes a second converter 3 and a second power distributor 30.

The second power distributor 30 receives power from the second converter 3 during driving and distributes the received power to a second battery 5 and second voltage loads. In FIG. 1, the second voltage loads are expressed by “Load 2.”

The second converter 3 converts the voltage of the high-voltage battery 1 into the second voltage.

Although the second voltage is, e.g., a voltage of 12 V as a rated voltage, the embodiment of the present disclosure is not limited thereto.

The second converter 3 may continuously output 14V power by converting the power of the high-voltage battery 1 when the startup state of the electric vehicle is the “EV Ready” state.

The second battery 5 that is a battery having a rated voltage of 12V may include one 12V lead-acid battery.

The second power distributor 30 distributes the power supplied from the second converter 3 to the second battery 5 and the second voltage loads.

To this end, the second power distributor 30 includes a second normal power line 33 that connects the second converter 3 to the second voltage loads and a second redundant power line 24 that connects the second battery 5 and the bidirectional converter 40 in parallel to the second voltage loads.

Also, the second power distributor 30 includes a third switch 31 that turns on/off an electrical connection between the first power system that supplies redundant power and the second converter 3 and a second switch 32 that turns on/off an electrical connection between the first power system and the second battery 5.

In this embodiment, the third switch 31 is connected between the second normal power line 33 and the second redundant power line 34, and the fourth switch 32 is connected between the second battery 5 and the second voltage loads on the second redundant power line 34. Also, the forth switch 32 is connected between the bidirectional converter 40 and the second battery 5 in terms of the redundant power supply.

The power supply apparatus may include a second controller that controls the third switch 31 and the forth switch 32 based on a state of the second converter 3 and/or the second battery 5 and performs a second reference value learning that will be described later.

Also, the second power distributor 30 may include a memory in which a computer program of control logic is stored and a microprocessor that loads and executes the program from the memory, and the second controller may include a processor of the second power distributor 30. For example, the processor of the second power distributor 30 may act as the second controller.

In this embodiment, the first controller is realized by the processor of the first power distributor 20, and the second controller is implemented by the processor of the second power distributor 30. However, the embodiment of the present disclosure is not limited thereto. Also, the first controller and the second controller may be implemented as a single integrated controller.

The second power distributor 30 includes a third sensor 35a for sensing a voltage and/or current output from the second normal power line 33 and a forth sensor 35b for sensing a voltage and/or current output from the second redundant power line 34.

The third sensor 35a is disposed between the second normal power line 33 and the third switch 31, and the forth sensor 35b is disposed at a rear end of a connection point between the third switch 31 and the second redundant power line 34.

Each of the third switch 31 and the fourth switch 32 may be a mechanical relay or a back-to-back switch.

When a current measured by the third sensor 35a is determined to be equal to or greater than the second reference value, the second power distributor 30 blocks the power supplied to the second voltage loads through the second normal power line 33. To this end, for example, the second power distributor 30 may turn off the second converter 3 and the third switch 31.

Also, when the second power distributor 30 detects a current output to the second converter 3, the second power distributor 30 may turn off the third switch 31. For example, an excessive amount of current may flow into the second converter 3 through the second power distributor 30 due to a fault in the second converter 3.

Each of the first power distributor 20 and the second power distributor 30 may include an active junction block including two back-to-back switches, a junction block circuit for power distribution, and a controller for controlling the same.

The bidirectional converter 40 selectively performs bidirectional voltage conversion between the first voltage and the second voltage.

The bidirectional converter 40 converts the second voltage into the first voltage when receiving a conversion request from the first power distributor 20 and converts the first voltage into the second voltage when receiving a request from the second power distributor 30.

The bidirectional converter 40 may include, e.g., a 2.5 kW-class single package, which is advantageous for layout and cost efficiency.

In this embodiment, the first voltage loads represent electronic devices driven by the first voltage as the rated voltage, and the second voltage loads represent electronic devices driven by the second voltage as the rated voltage.

The first voltage loads and the second voltage loads may include, e.g., a braking device, a steering device, and electronic devices for general or convenience purposes. Although, in this embodiment, the first voltage loads include autonomous driving loads as an example, the embodiment of the present disclosure is not limited thereto. The autonomous driving loads may also be included in the second voltage loads.

Here, the autonomous driving loads may include various sensors (e.g., LiDAR, radars, ultrasonic sensors, vehicle state detection sensors including a vehicle speed) required for autonomous driving and an autonomous driving controller (e.g., a processor and a memory in which autonomous driving logic is stored).

The term “electronic devices for general purposes or for convenience” has a meaning relative to essential devices for driving and refers to electronic devices except for the essential devices for driving.

For example, the electronic devices for general purposes or for convenience include air conditioning systems, audio/video systems, and interior lighting.

The essential device for driving includes, e.g., a braking device, a steering device, a communication device, an instrument cluster, a headlamp, and an autonomous driving load.

In this embodiment, the first redundant power line 24 and the second redundant power line 34 are connected to supply power to the essential device for driving and not to supply power to other devices. On the other hand, the first normal power line 23 and the second normal power line 33 are connected to supply power to both the essential devices for driving and other electronic devices for general purposes or for convenience. However, the embodiment of the present disclosure is not limited thereto.

On the other hand, power supplied through the first normal power line 23 and the second normal power line 33 and consumed by the essential devices for driving in the normal state may be different from power supplied through the first redundant power line 24 and the second redundant power line 34 and consumed in the redundant power supply state. The former may represent an amount of power that allows the devices to operate at full power, while the latter may represent restricted power (e.g., power restricted below the full power based on functional restriction) in the redundant power state.

Although not shown, in this embodiment, at least some or all of the high-voltage battery 1, the first converter 2, the first power distributor 20, the first voltage loads, the first battery 4, the bidirectional converter 40, the second converter 3, the second power distributor 30, the second voltage loads, and the second battery 4 may be connected to a communication network to exchange information with one another:

The communication network may be, e.g., a controller area network (CAN), a local interconnect network (LIN), FlexRay, or Ethernet.

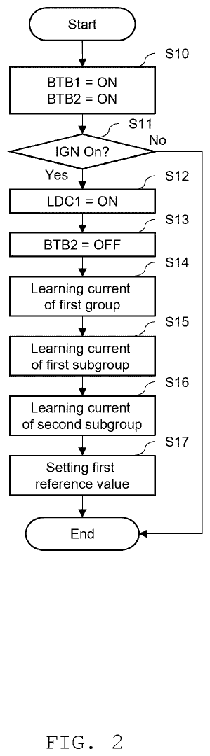

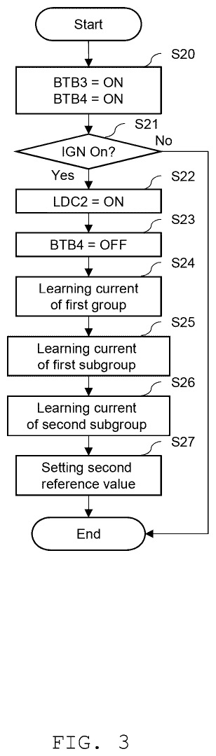

Hereinafter, a learning process for a first reference value and a second reference value will be described with reference to FIGS. 2 and 3.

As described above, in this embodiment, the first reference value learning is performed in the first controller 26, and the second reference value learning is performed in the second controller 36. However, the embodiment of the present disclosure is not limited thereto.

First, the first reference value learning will be explained with reference to FIG. 1.

Referring to FIG. 2, the first controller 26 turns on the first switch 21 and the second switch 22 to an on-state in step S10.

In step S11, the first controller 26 determines whether a start button of a vehicle is in an “IGN On” mode. In the “IGN On” mode, the vehicle may be in an ignition-on state in which power is supplied to loads required for driving. In this state, the vehicle moves forward when a brake pedal is released or an accelerator pedal is pressed.

When the vehicle is switched to the “IGN On” mode, the first converter 2 and the second converter 3 are activated.

In FIG. 2, step S12 indicates that an operation of the first converter 2 is initiated as the vehicle is converted into the “IGN On” mode.

In step S13, the first controller 26 turns off the second switch 22 to block influence from the first battery 4.

Thereafter, in step S14, the first controller 26 learns a first group 10a among the first voltage loads based on a monitored output current of the first group 10a.

Also, in steps S15 and S16, the first controller 26 learns an amount of current consumption of a first subgroup 11a and a second subgroup 11a2 among the first voltage loads based on a forced output command to perform learnings for the corresponding groups.

In this embodiment, the first voltage loads may be classified into the first group 10a and the second group 11a, and the second group 11a may be further classified into the first subgroup 11al and the second subgroup 11a2.

The first group 10a may include loads to which power is basically supplied in the “IGN On” mode, and the second group 11a may include loads to which power is supplied based on options.

The first group 10a may have a set amount of applied current as a default, and the second group 11a may include loads having a varied amount of applied current depending on user selection or states of related systems.

The amount of current for the first group 10a may be learned based on a rated output of the corresponding loads, and the amount of current for the second group 11a may be learned by maximally setting an output of the corresponding loads by the forced command and monitoring consumed current thereof.

In this embodiment, the first group 10a includes loads related to devices for convenience, and the second group 11a may be further classified into a steering and braking device (first subgroup 11a1) and an autonomous driving load (second subgroup 11a2).

When the learnings on the current for the groups are completed, the first controller 26 determines the first reference value in step S17 based on the learnings.

For example, the first reference value may be determined by adding all of the currents learned in steps S15, S16, and S17. Here, a safety coefficient may be applied. That is, e.g., a safety coefficient of 1.1 may be applied, and 110% of added values may be determined as the first reference value.

Thereafter, the second reference value learning will be described with reference to FIG. 3.

Referring to FIG. 3, in step S20, the second controller 36 turns on the third switch 31 and the fourth switch 32 to the on-state.

In step S21, the second controller 36 determines whether the start button of the vehicle is in the “IGN On” mode.

In FIG. 2, step S22 indicates that operation of the second converter 3 is initiated as the vehicle enters the “IGN On” mode.

In step S23, the second controller 36 turns off the fourth switch 32 to block influence from the second battery 5.

Thereafter, in step S24, the second controller 36 learns the corresponding group based on a monitored output current result for the third group 10b (which may be second voltage loads classified based on the same reference as the first group 10a) among the second voltage loads.

Also, in steps S25 and S26, the second controller 36 learns an amount of current consumption according to a forced output command for the third subgroup 11b1 (which may be the second voltage loads classified based on the same reference as the first subgroup 11a1) and the fourth subgroup 11b2 (which may be second voltage loads classified based on the same reference as the second subgroup 11a2) among the second voltage loads and performs learnings for the corresponding groups.

The second voltage loads may be also classified into a third group 10b and a fourth group 11b, and the fourth group 11b may be further classified into a third subgroup 11b1 and a fourth subgroup 11b2. Since the third group 10b and the third subgroup 11b1 and the fourth subgroup 11b2 are similar to the above descriptions of the first voltage loads, a detailed description thereof will be omitted.

When the learnings on the currents for the groups are completed, the second controller 36 determines the second reference value in step S27 based on the learnings.

For example, as with the first reference value, the second reference value may be determined by adding all the currents learned in steps S25, S26, and S27. Here, the safety coefficient may be also applied. That is, e.g., a safety coefficient of 1.1 may be applied, and 110% of the added values may be determined as the second reference value. Here, the safety coefficient applied to the second voltage loads may be different from that used for the first voltage loads.

The learning for the first and second reference values may be performed once or a plurality of times.

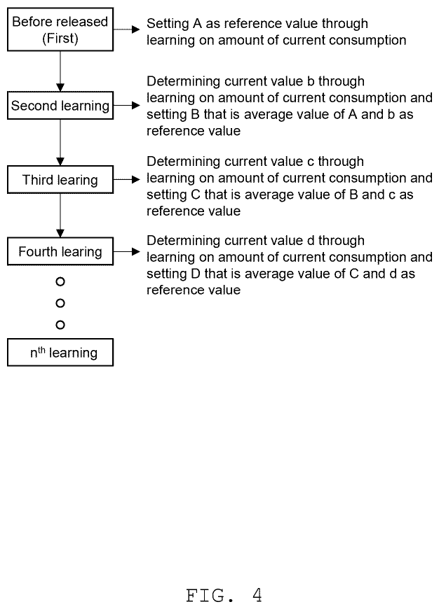

FIG. 4 is a flowchart illustrating an embodiment in which the learning is performed a plurality of times, which, hereinafter, will be described.

Referring to FIG. 4, the learning may be firstly performed once at a final step of a production line before the vehicle is released.

Thereafter, subsequent learnings may be performed after update of related software is performed or when vehicle maintenance is performed.

For example, when the software of the first controller 26 or the second controller 36 is updated, a second learning may be performed as shown in FIG. 4.

When the second learning is completed, an average of a current learning value b determined in the second learning and an existing reference value A is set again as the reference value.

Thereafter, subsequent learnings such as third and fourth learnings may be performed, and an average of a current learning value learned from respective learnings and the previous reference values is set again as the reference value.

That is, in the embodiment of FIG. 4, the learnings are performed a plurality of times, and an accumulated average of the current learning values is updated as the reference value.

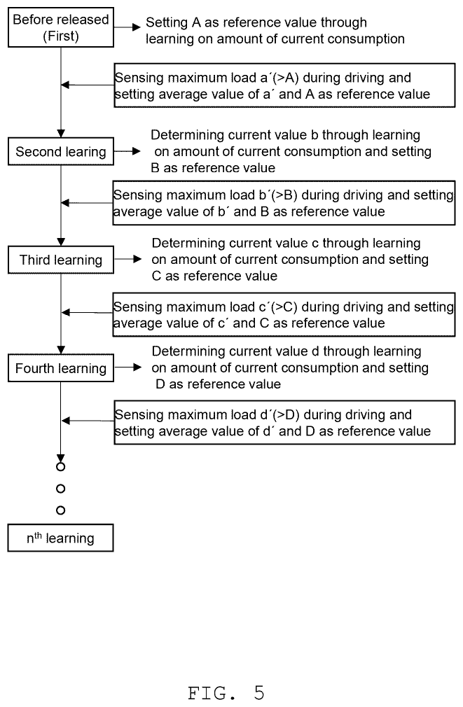

FIG. 5 is a flowchart illustrating another embodiment of the learning, which, hereinafter, will be described.

In an embodiment of FIG. 5, the learning is firstly performed once at the final step of the production line before the vehicle is released, and the learning is repeated when the software is updated or the vehicle maintenance is performed.

However, in the embodiment of FIG. 5, since the learning is repeated when the accumulated average is not used, the reference value is determined and updated based on the current learning value obtained from respective learnings.

Here, when a maximum current consumption of the voltage loads exceeds the reference value determined in a given learning, an average of the excess value and the existing reference value is set as the new reference value.

For example, in FIG. 5, when the reference value is determined as A during first learning, and a maximum current load a′ for the voltage loads is greater than the existing reference value A, an average of the maximum current load a′ and the existing reference value A may be set as the new reference value.

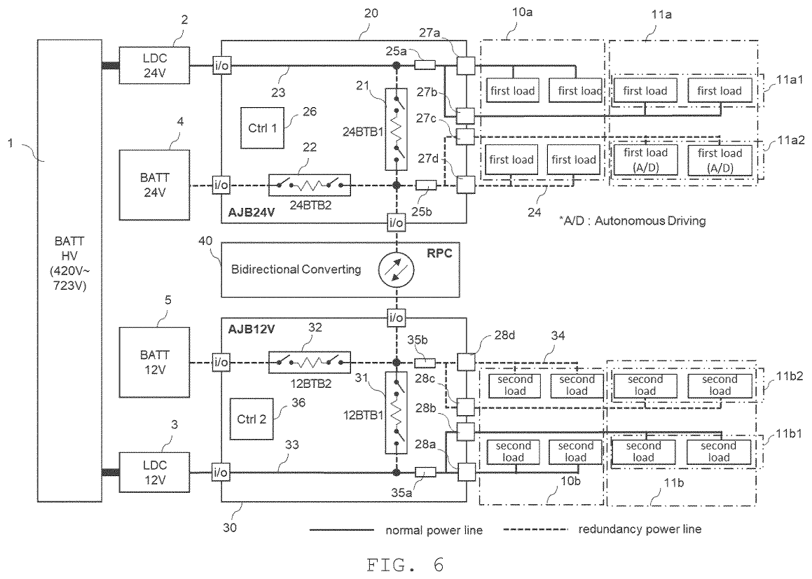

FIG. 6 is a view illustrating a power supply apparatus according to another embodiment of the present disclosure, which, hereinafter, will be described.

In the power supply apparatus in FIG. 6, the first voltage loads and the second voltage loads are respectively classified into a plurality of groups, and output elements for each group are connected to control an output of the current.

That is, the first power distributor 20 may include output elements 27a to 27d for each group among the first voltage loads, and the first controller 26 may measure an output current of the output elements 27a to 27d for each group and perform learnings thereof.

Also, in this embodiment, the second power distributor 30 may include output elements 28a to 28d for each group among the second voltage loads, and the second controller 36 may measure an output current of the output elements 28a to 28d for each group and perform learnings thereof.

Here, each of the output elements may be a semiconductor element or a relay.

According to at least one embodiment of the present disclosure, the redundant power supply technology capable of managing various abnormal situations may be obtained.

Also, according to at least one embodiment of the present disclosure, the redundant power supply apparatus capable of blocking the supply of power when the overcurrent flows through the power load may be obtained.

Also, according to at least one embodiment of the present disclosure, the redundant power supply apparatus capable of blocking the current flowing the converter when the failure state of the converter that converts the voltage of the high-voltage battery for power supply to the power loads occurs may be obtained.

Although the exemplary embodiments of the present invention have been described, it should be understood that the present invention is not limited to these embodiments, and various changes and modifications may be made by one of ordinary skill in the art without departing from the spirit and scope of the invention as defined by the following claims. Accordingly, the true scope of protection of the present invention shall be determined by the technical scope of the accompanying claims.

What is claimed is:

1. A power supply apparatus comprising:
a first converter configured to convert a voltage of power supplied from a power supply source into a first voltage;
a first power distributor configured to distribute a first current of the first voltage to first voltage loads; and
a redundant power system configured to supply redundant power to the first power distributor,
wherein the first power distributor comprises a first switch configured to switch on/off an output of the first power distributor when a current output from the first power distributor to the first voltage loads is greater than or equal to a first reference value.

2. The power supply apparatus of claim 1, wherein the first switch switches off as the current is output to the first converter.

3. The power supply apparatus of claim 1, further comprising a first controller configured to determine the first reference value through learning.

4. The power supply apparatus of claim 3, wherein the first power distributor further comprises a second switch configured to switch an electrical connection with a first battery, and
the first controller is configured to switch off the second switch and perform the learning.

5. The power supply apparatus of claim 4, wherein the first controller performs the learning on a first group among the first voltage loads based on monitored results of a current output according to an operation of the first converter and performs the learning on a second group among the first voltage loads based on an amount of current consumption measured in response to a forced output command.

6. The power supply apparatus of claim 4, wherein the first power distributor comprises output elements corresponding to respective groups among the first voltage loads, and
wherein the first controller measures an output current of the output elements for respective groups to perform the learning.

7. The power supply apparatus of claim 3, wherein the first reference value is determined as a cumulative average of current learning values of the learnings performed in a plurality of times.

8. The power supply apparatus of claim 3, wherein the first reference value is updated as the learning is repeated, and
wherein the first reference value determined by each learning is updated by an average with an excess value when a maximum current consumption of the first voltage loads is greater than the first reference value.

9. The power supply apparatus of claim 3, wherein the first controller comprises a processor of the first power distributor.

10. The power supply apparatus of claim 1, wherein the first power distributor comprises a first power line that connects the output current of the first converter to a portion of the first voltage loads and a second power line that connects the output current of the first converter to another or overlapping portion of the first voltage loads, and
wherein the first switch is connected between the first power line and the second power line.

11. The power supply apparatus of claim 10, wherein the redundant power system is connected to the second power line.

12. The power supply apparatus of claim 1, wherein the redundant power system comprises:
a second converter configured to convert a voltage of power supplied from the power supply source into a second voltage; and
a second power distributor configured to distribute a second current of the second voltage to second voltage loads and receive redundant power from the first power distributor, and
wherein the second power distributor comprises a third switch configured to switch on or off an output of the second power distributor when a current output from the second power distributor to the second voltage loads is greater than or equal to a second reference value.

13. The power supply apparatus of claim 12, wherein the third switch is switched off as the current is output to the second converter.

14. The power supply apparatus of claim 13, further comprising a second controller configured to determine the second reference value through learning.

15. The power supply apparatus of claim 14, wherein the second power distributor further comprises a fourth switch configured to switch an electrical connection with the second battery, and
wherein the second controller is configured to switch off the fourth switch and perform the learning.

16. The power supply apparatus of claim 15, wherein the second controller is configured to perform the learning on a third group among the second voltage loads based on monitored results of a current output according to an operation of the second converter and perform the learning on a fourth group among the second voltage loads by an amount of current consumption in response to a forced output command.

17. The power supply apparatus of claim 14, wherein the second controller comprises a processor of the second power distributor.

18. The power supply apparatus of claim 12, wherein the second power distributor comprises a third power line that connects the output current of the second converter to a portion of the second voltage loads and a fourth power line that connects the output current of the second converter to another or overlapping portion of the second voltage loads, and
wherein the third switch is connected between the third power line and the fourth power line.

19. The power supply apparatus of claim 18, wherein the first power distributor is connected to the fourth power line.

20. The power supply apparatus of claim 12, further comprising a bidirectional converter connected between the first power distributor and the second power distributor.
